(19) United States
(12) Patent Application Publication
(10) Pub. No.: US 2013/0094642 A1
(43) Pub. Date: Apr. 18, 2013

(54) CALL SCHEDULING SYSTEM

(71) Applicants: Denis L. Sverdlov, Sankt-Peterburg (RU); Sergey Mikhaylov, Velikiy Novgorod (RU)

(72) Inventors: Denis L. Sverdlov, Sankt-Peterburg (RU); Sergey Mikhaylov, Velikiy Novgorod (RU)

(73) Assignee: Rawllin International Inc., Tortola (VG)

(21) Appl. No.: 13/273,844

(22) Filed: Oct. 14, 2011

(51) Int. Cl. H04M 3/42

(52) U.S. Cl. 379/201.03

(57) ABSTRACT

Disclosed are call schedule systems and techniques for establishing a phone call with one or more participants. A scheduled time can be set for the phone call and one or more messages related to joining the phone call at the scheduled time can be sent to one or more recipient devices. At the scheduled time of the phone call, a notification can be generated to determine whether to start the phone call. In this regard, one or more phone calls can be simultaneously transmitted to the one or more recipient devices in response to an action initiating the start of the phone call.

### TECHNICAL FIELD

The subject application relates generally to scheduling and establishing a call with one or more call participants.

### BACKGROUND

Current call schedule applications provide a way to schedule a phone call (e.g., a conference call) with a host and one or more participants. The host may install a call schedule application on a device. Alternatively, the host may also access a web-based call schedule application via a web browser. To schedule the phone call, the host selects a time and date for the phone call. The host may then invite call participants by manually entering a phone number of a desired call participant, or by selecting a desired call participant from an address book. At the selected time and date for the phone call, each of the invited call participants may receive a reminder regarding the phone call. In response to the reminder, the host and the invited call participants may each dial a host phone number to connect to the host phone number and start the phone call.

However, conventional methods of scheduling a phone call with the invited call participants lack an efficient and simplified way to start the phone call with the invited call participants. For instance, in conventional call schedule applications, the invited call participants have to make an effort to dial the host phone number (e.g., physically dial the host phone number). As a result, an invited call participant is required to remember and correctly dial the host phone number to join the call. Additionally, an invited call participant has to take the time to dial the specific host number to join the call. Furthermore, if the invited call participant neglects the reminder and does not dial the host phone number, the participant misses the call. In addition, the invited call participant is not provided with an easy way to reschedule the call or inform the host of a convenient time to reschedule the call.

Additionally, the host that scheduled the call at the selected time and date may not be ready to start the call at the selected time and date. Therefore, invited call participants may dial and connect to the host phone number when the host that scheduled the call is not available to start the call. Consequently, the invited call participants may waste time waiting for the host to join the call. As such, conventional systems and methods of scheduling a phone call with one or more participants lack efficiency and simplicity.

The above-described deficiencies of today's call scheduling systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for systems that incorporate scheduling and managing a call are contained herein. An exemplary method is provided that includes the steps of storing a scheduled time for a call, sending one or more messages related to joining the call at the scheduled time to one or more recipient devices, generating a notification at the scheduled time to determine whether to start the call, and transmitting one or more calls simultaneously to a respective destination number of the one or more recipient devices from an invitation number in response to an action initiating the start of the call.

In another non-limiting embodiment, an exemplary call schedule system includes a schedule component configured to set a scheduled time for a call, a management component configured to send one or more messages related to an invitation to join the call at the scheduled time to one or more recipient devices, and an initiation component configured to generate a notification at the scheduled time to determine whether to start the call and automatically transmit one or more calls simultaneously to a respective destination number of the one or more recipient devices from an invitation number in response to an action to initiate the start of the call.

In still another non-limiting embodiment, an exemplary computer readable storage medium that includes computer executable instructions that, in response to execution by a computing system, cause the computing system to perform operations, including storing a scheduled time for a call, sending one or more messages related to joining the call at the scheduled time to one or more recipient devices, generating a notification at the scheduled time to determine whether to start the call, and transmitting one or more calls simultaneously to a respective destination number of the one or more recipient devices from an invitation number in response to an action initiating the start of the call.

In yet another non-limiting embodiment, an exemplary system is provided that includes means for storing a scheduled time for a call, means for sending one or more messages related to joining the call at the scheduled time to one or more recipient devices, means for generating a notification at the scheduled time to determine whether to start the call, and means for transmitting one or more calls simultaneously to a respective destination number of the one or more recipient devices from an invitation number in response to an action initiating the start of the call.

In still another non-limiting embodiment, an exemplary method is provided that includes saving a start time for a call, presenting one or more messages related to joining the call at the start time to one or more devices, sending a notification at the start time to determine whether to begin the call, and transmitting one or more calls simultaneously to the one or more devices in response to an action to begin the transmitting of the one or more calls.

These and other embodiments are described in more detail below.

### BRIEF DESCRIPTION OF DRAWINGS

FIG. 1 illustrates an example of a call scheduling system;

FIG. 2 illustrates an example of various components in a call scheduling system in accordance with various aspects described herein;

FIG. 3 illustrates an example of a notification in a call scheduling system in accordance with various aspects described herein;

FIG. 4 illustrates an example of displayed information in a call scheduling system in accordance with various aspects described herein;

FIG. 5 illustrates an example of options for selecting participants in a call scheduling system in accordance with various aspects described herein;

FIG. 6 illustrates an example call scheduling system in accordance with various aspects described herein;

FIG. 7 is a flow diagram illustrating an exemplary non-limiting process for a call scheduling system;

FIG. 8 is a flow diagram illustrating an exemplary non-limiting process for managing a call scheduling system;

FIG. 9 is a flow diagram illustrating an exemplary non-limiting process for initializing a call scheduling system;

FIG. 10 is a flow diagram illustrating an exemplary non-limiting process for participating in a call scheduling system;

FIG. 11 is a flow diagram illustrating an exemplary non-limiting process for facilitating a call scheduling system;

FIG. 12 is a flow diagram illustrating another exemplary non-limiting process for a call scheduling system;

FIG. 13 is a block diagram illustrating an example networking environment that can be employed in accordance with the claimed subject matter;

FIG. 14 is a block diagram illustrating an example computing device that is arranged for at least some of the embodiments of the claimed subject matter; and

FIG. 15 illustrates an example of a mobile device that can process content in accordance with the claimed subject matter.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

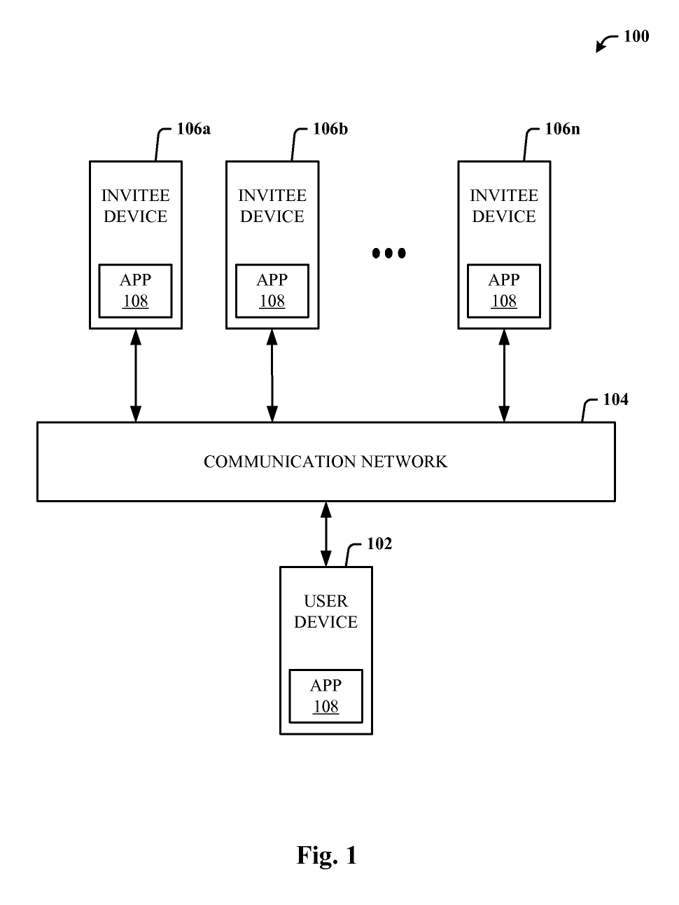

Referring initially to FIG. 1, a block diagram illustrating an example, non-limiting embodiment of a call system 100 for scheduling a call is shown. The call system 100 is provided to establish, manage and facilitate a call among multiple users. The call system 100 can include a user device (e.g., host device) 102, a communication network 104, and one or more invitee devices (e.g., one or more recipient devices) 106a-n. In one example, the user device 102 and/or the one or more invitee devices 106a-n can be mobile devices (e.g., mobile phones, cell phones, smart phones, handheld devices, etc.). However, the user device 102 and/or the one or more invitee devices 106a-n can also include, but is not limited to, computers, laptops, tablets, etc. The user device 102 and the one or more invitee devices 106a-n can be operated by call participants (e.g. a host, users, invitees, etc.). The user device 102 can be operated by a host (e.g., a call host, user) to establish a call at a scheduled time (e.g., a specified time, a date and time) with the one or more invitee devices 106a-n.

An application (e.g., call schedule application) 108 can be installed and operated on the user device 102 to facilitate establishing the call at the scheduled time. A user can install an application (e.g., a call schedule application) 108 on the user device 102 (e.g., a mobile phone, a desktop, a laptop, a tablet, etc). In one example, the application 108 is a client application installed and operated on the user device 102 to facilitate the call schedule. A user can also navigate to a website via a web browser to access the application 108. To set a call schedule, a user registers and adds an online or offline phone number (e.g., an invitation number) for the call to the application 108. In one example, the added phone number is a phone number associated with the user device 102. Optionally, a user can set up an address book and/or call groups. The address book and/or call groups can contain mobile phone number, landline phone numbers, and/or web-based call service identifications (e.g., a screen name, a user name, etc.) associated with a web or traditional phone number for the one or more invitee devices 106a-n. The application 108 can also be a hosted online application. Information can be synchronized between different applications associated with the user. For example, information entered by the user device 102 can be accessible and/or editable from a web-based application and web browser upon the user login.

The user device 102 and/or the invitee devices 106a-n mobile can include, for example, a cell phone, smart phone, personal digital assistant, tablet, laptop computer, etc. The user device 102 and/or the invitee devices 106a-n can connect to the communication network 104 via a wireline or wireless communication connection. In one example, the user device 102 and/or the invitee devices 106a-n are capable of wireless communication at least in part over the communication network 104 (e.g., a mobile communication network, a cellular network, a WiFi network, a WiMAX network, etc.). The communication network 104 can include desired components, such as routers, nodes, switches, interfaces, controllers, etc., that can facilitate communication of data between the user device 102 and/or the invitee devices 106a-n.

To set a new call schedule for a phone call (e.g., a conference call), a user (e.g., the host) can optionally enter a name and/or an agenda for the phone call using the user device 102 with the application 108 or a web-based application 108. Then, the user can select a scheduled time (e.g., a date and a time) for the phone call. Next, the user can select one or more invitees for the phone call by manually entering phone numbers of the one or more invitees and/or by selecting names (e.g., phone numbers) of the one or more invitees from the address book. In one example, the user selects one or more invitees from a call group. One or more invitations (e.g., messages) can be sent from the user device 102 to the one or more invitee devices 106a-n. Sending the one or more invitations can be managed using the call schedule application 108.

The invitee devices 106a-n can receive the one or more invitations from the user device 102 via various types of messages including, but not limited to, text messages, email, notification pop-up messages, etc. In one example, the one or more invitations are sent to the application 108 installed on the invitee devices 106a-n. In another example, the one or more invitations are not sent to the application (e.g., the invitations are sent to an email account not affiliated with the application 108). The type of communication method can depend on the type of invitee device 106a-n and/or preferences set by the invitees. The system 100 can determine the type of device 106a-n and select the appropriate form of notification (e.g., invitation, message, etc.). In one example, the one or more invitations can be sent using a default method of notification.

After an invitation is received by the one or more invitees, the invitation can be accepted using the invitee devices 106a-n. Once the invitation is accepted, a schedule status can be updated to notify the user and other invitees about the call schedule status (e.g., the number of call participants). For example, a schedule status can be presented to the user and other invitees to display which of the call participants have accepted the invitations. In addition, the one or more invitees can add other recipients to the call by forwarding the invitation for the call to other recipients.

In one embodiment, the one or more invitees can type and send suggestions and/or comments to the host and/or other invitees. For example, an invitee can send a suggestion to change and/or edit the call name or agenda. In one example, the suggestion and/or comments are sent to a select number of call participants. For example, the suggestion and/or comments can be sent only to the host and not to other invitees.

At the set date and time (e.g., the scheduled time) for the call, the user device 102 (e.g., the host) can receive a notification. The host can then choose to start the call, reject the call, or propose a new date and/or time for the call. In one example, the user can start the call by pressing a start button (e.g., a start button in the call schedule application 108) on the user device 102. The start button can be, for example, implemented in the application 108, implemented as a button on a touch screen, implemented as a button on the user device 102, or another type of user interface control. However, it is to be appreciated that another type of action can be used to initiate the start of the call. For example, the start of the call can be initiated by accessing a web-based version of the application 108 on a computer and choosing an option to start the call via the web-based version of the application 108.

If the host decides to start the call, the application 108 installed on the user device 102 simultaneously calls all of the invitee devices 106a-n (e.g., all of the invitee devices 106a-n ring simultaneously to a respective destination phone number of the invitee devices 106a-n). Therefore, the host is not required to call each individual invitee. Additionally, each of the invitees are not required to call a phone number (e.g., an invitee number) associated with the user device 102. The application 108 can display a connection status of the call on the user device 102 and/or the invitee devices 106a-n. In one example, a phone waiting ring can be silenced while waiting for invitees to join the call. All the recipients of the call (e.g., the invitee devices 106a-n) are joined to the call (e.g., the user device 102) after the connection is initiated.

If the one or more of the invitee devices 106a-n (e.g., a respective destination number of one or more of the invitee devices 106a-n) is busy or not answering the call, an option to set a future call (e.g., a new call, a new conference call) can be presented to the user device 102 and/or one or more of the invitee devices 106a-n. The phone number (e.g., the invitation number) of the user device 102 can be presented to a particular one of the invitee devices 106a-n if a particular one of the invitee devices 106a-n did not answer the call (e.g., rejected the call). In one example, a call button (e.g., interface control) is presented to the particular one of the invitee devices 106a-n that did not answer the call if the call is still in progress. In another example, a schedule new call button (e.g., to schedule a future call) is presented to the particular one of the invitee devices 106a-n that did not answer the call (e.g., rejected the call) if the call is no longer in progress. Therefore, one of the invitee devices 106a-n can submit a time and/or date for a new call with the user device 102. In one example, the user device 102 can receive a message (e.g., a text message, an email, a pop-up message, etc.) with the time and/or date for the new call from one of the invitee devices 106a-n. As such, the time and/or date for the new call can be accepted and automatically scheduled using the user device 102. Alternatively, the time and/or date for the new call can be rejected, and another proposed time and/or date for the new call can be generated, using the user device 102.

At the end of the call, details regarding the call (e.g., call details) can be stored and/or presented to the call participants (e.g., the user device 102 and the invitee devices 106a-n). For example, a history record, including date of the call, time of the call, duration of the call, and participants of the call can be saved in connection with the host and/or invitees. In one embodiment, the host and/or invitees can add personal or public notes about the call to share with one or more of the call participants. In one example, the personal or public notes about the call are shared with all the call participants. In another example, the personal notes about the call are shared with a select number of the call participants.

In one embodiment, the application 108 installed and/or accessed on the user device 102 and/or the invitee devices 106a-n can access a calendar of the host or the invitees. In one example, the calendar can be stored on the user device 102 and/or the invitee devices 106a-n. In another example, the calendar can be linked to the application 108. Therefore, the application 108 can suggest (e.g., determine) a date and/or time for the call based on the availability of the invitees. As such, a date and/or time for the call can be chosen without asking the invitees for an available date and/or a time for the call. Therefore, a user does not have to determine a best date and/or time for the call.

The user device 102 and/or the invitee devices 106a-n can be employed to generate, receive, or display messages or requests, such as, but not limited to, text messages, instant messages, multimedia messages, email messages, voice mail messages, notifications, etc. The user device 102 and/or the invitee devices 106a-n can provide respective message interfaces (e.g., a user interface) in relation to the respective types of messages.

In one embodiment, the application 108 can comprise one or more applications. For example, the application 108 can include a mobile application, a web browser application, a message application, a call application, a contact list application, a call details application, and/or other desired applications, which can be pre-installed or downloaded onto the user device 102 and/or the invitee devices 106a-n at a desired time. Respective applications can provide respective application interfaces that can be provided to the user via a user interface (e.g., a display).

In another embodiment, the application 108 can maintain a user profile that that can be employed to generate and maintain a user profile of a user. The user profile can include call information relating to the user. For example, the user profile can comprise user preferences of the user in relation to call schedules, past calls, preferred call participants, etc. The user, using the application 108, can create or modify the user profile, as desired.

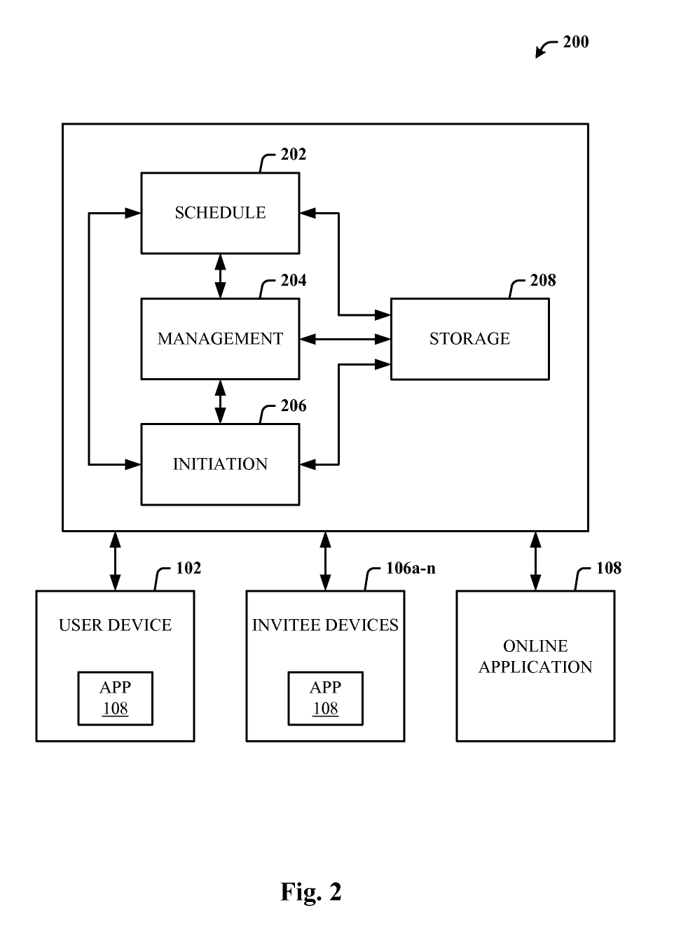

Turning to FIG. 2, a block diagram illustrating an example, non-limiting embodiment of various components in a call schedule system 200 is shown. The call schedule system 200 can be implemented in hardware, software, firmware, or a suitable combination thereof. In addition, the call schedule system 200 can be modular, having different functions implemented by different components that interact among themselves. Updates of these functions can be implemented independent of, or in conjunction with, related functions via software/firmware update, hardware update, or the like, or a combination thereof. The call schedule system 200 can include a schedule component 202, a management component 204, an initiation component 206, and a storage component 208. In one example, the call schedule system 200 can be implemented on the user device 102 and/or the invitee devices 106a-n (e.g., implemented via the application 108). In another example, the call schedule system 200 can be accessed by the application 108, the user device 102, and/or the invitee devices 106a-n (e.g., accessed over the communication network 104). In one example, the application 108 can be an online application. In another example, the application 108 can be an application installed on the user device 102 and/or the invitee devices 106a-n.

The schedule component 202 can set a scheduled time (e.g., a date and/or a time) for a call. The date and/or time for the call can be saved in the storage component 208. In one example, the scheduled time is a specific time to start of the call (e.g., start the call at 11 am). In another example, the scheduled time is a time range to start the call (e.g., the call will begin between 11 am and 11:30 am). Therefore, the user device 102 can receive a notification to start the call, for example, at 11 am, but the one or more invitees can be notified to expect a call, for example, between 11 am and 11:30 am. The management component 204 can be implemented to invite one or more recipients to join the call. For example, the management component 204 can send an email or a text message to one or more recipients to invite the one or more recipients to the call at the set date and/or time. The initiation component 206 can be implemented to generate a notification at the set date and/or time to start the call. For example, a signal can be received from the schedule component 202 at the set time and/or date to send a notification to the user device 102 at the set date and/or time. In another example, the initiation component 206 generates a notification for the user device 102 in response to the stored date and/or time in the storage component 208. In response to an action initiated by the user device 102 (e.g., the host), the initiation component 206 can automatically transmit one or more calls simultaneously to a destination number (e.g., a phone number) of each of the one or more recipients from an invitation number (e.g., a phone number) of the user device 102. For example, the action can be pressing a user interface control (e.g., a start button) on the user device 102 to start the call. Therefore, the host does not need to dial a phone number for each of the one or more recipients and the one or more recipients do not need to dial a phone number of the host.

The schedule component 202 can be configured to set a date and time for a call. The schedule component 202 can assist selection of invitees for a scheduled call from a list of email contacts, mobile phone contacts, an address book, etc. The schedule component 202 can also be configured to automatically check a schedule (e.g., a calendar) of call participants to determine a best date and/or time to schedule a call. For example, the schedule component 202 can determine one or more dates and times for the call based on a calendar saved or linked to the user device 102 and/or the invitee devices 106a-n. Therefore, a list of possible dates and times for the call can be presented to the user device 102 based on the availability of the call participants. A user can also manually input a date and time for the call via the application 108 on the user device 102 or another device with access to the application 108.

The schedule component 202 can also be configured to determine a possible date and time for a future call if an invitee is busy or not answering the call at the original date and time of the call. The possible date and time for the future call can be presented to the invitee that missed the original call. Therefore, the invitee that missed the original call can choose a date and time for the future call. The invitee that missed the original call can also manually input a date and time for the future call. A notification can be sent to other call participants regarding the future call. For example, a message (e.g., a text message, an email, a pop-up message, etc.) can be sent to the user device 102 from one of the invitee devices 106a-n to propose a scheduled time for the future call. Therefore, an invitee that missed the original call and/or rejected the original call can notify the other call participants of a convenient time and/or date for the future call. Additionally, notes regarding the original call can be sent to the invitees that missed the original call.

The management component 204 can be configured to notify an invitee (e.g., a call participant, a recipient, etc.) of a call request. The notification can be provided, for instance, to a user interface (e.g., a display) of a device (e.g., the invitee devices 106a-n). The invitee can be a subscriber (e.g., a user that has downloaded and installed the application 108) of a call schedule application. The invitation for the call can be, for example, in the form of a message notification (e.g., text message, voice message, short message service (SMS), multimedia messaging service (MMS) message, e-mail message, pop-up message, etc.), a graphic notification (e.g., a picture), a video notification, an audio notification (e.g., beep, music clip, voice clip, etc.), or the like, or a suitable combination thereof. The notification can also provide at least some indication or information about the scheduled call. For example, the message notification can further comprise a date and/or time of the call, call participants, notes regarding the call, etc. An invitee can accept the invitation to join the call, reject the invitation to join the call, or propose a new time for the call. The response from the invitee regarding the invitation to join the call can be received by the management component 204. Additionally, the response from the invitee can be made available to other call participants via the application 108. The management component 204 can also be configured to display a connection status of the call to each of the call participants. For example, the names of the call participants connected to the call and/or the number of call participants connected to the call can be displayed.

The initiation component 206 can be configured to send a notification to the user device 102 at the scheduled time (e.g., the chosen time and date for the call). A user can initiate the start of the call by pushing a start button (e.g., a start control, a user interface control, etc.) on the user device 102. The initiation component 206 can simultaneously transmit one or more calls to a respective destination number of the invitee devices 106a-n from an invitation number of the user device 102 in response to the initiation to start the call.

The storage component 208 can be configured to store details regarding a call. For example, the storage component 208 can store a history record of a call, the time of the call, the date of the call, duration of the call, or participants of the call. However, it is to be appreciated that other details regarding a call can be stored on the storage component 208. The storage component 208 can store, for example, data structures (e.g., user data, metadata), code structure(s) (e.g., modules, objects, hashes, classes, procedures) or instructions, information relating to generating, sending, receiving or processing call schedules. In an aspect, schedule component 202, the management component 204 and/or the initiation component 206 can be functionally coupled (e.g., through a memory bus) to the storage device 208 in order to store and retrieve information desired to operate and/or confer functionality, at least in part, to the application 108 (e.g., the user device 102 and/or the invitee devices 106a-n). In one example, the storage component 208 comprises a network of storage components.

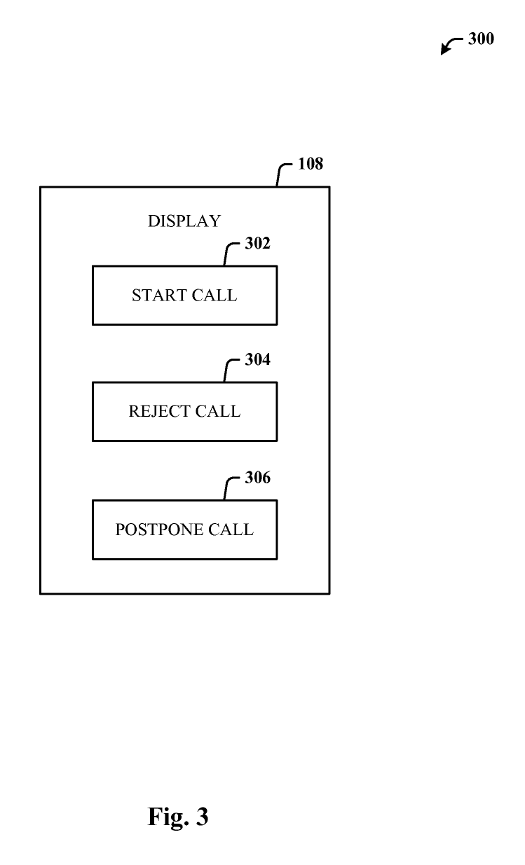

Turning to FIG. 3, a block diagram illustrating an example, non-limiting embodiment of a system 300 for displaying a notification in a call scheduling system is shown. The notification can be generated by the application 108. In one example, the notification can be displayed on the user device 102 (e.g., the application 108). For example, the notification can be displayed on a mobile phone (e.g., a smart phone). However, the notification can be obtained from another device with access to the application 108. For example, the notification can be accessed using another device with a web-browser (e.g., a computer, a laptop, a tablet, a handheld device, etc.). The notification can be sent to the user device 102 (e.g., a host) at scheduled time for the call set previously by the call host. The notification can provide a number of options for the call host regarding the call. For example, each of the options can be implemented in the call schedule application 108 as a button (e.g., a user interface control). Therefore, to choose an option, the host can push one of the options on the user device 102. The notification can comprise an option (e.g., button, user interface control) 302 to start the call, an option (e.g., button, user interface control) 304 to reject the call and an option (e.g., button, user interface control) 306 to postpone the call. If the option 302 is selected by the user (e.g., the button 302 is pressed by the user), the call can begin. As a result, one or more calls form an invitation number (e.g., a phone number) of the user device 102 can be simultaneously transmitted to a destination number (e.g., a phone number) of each of the one or more invitee devices 106a-n. If the option 304 is selected by the host, the call can be rejected. As a result, the call is canceled. A notification can be sent to each or the one or more invitee devices 106a-n if the call is cancelled to inform the one or more invitees that the call has been cancelled. If the option 306 is selected by the host, the call can be postponed. As a result, the host can set a new date and/or time for the call. A notification can be sent to each of the one or more invitee devices 106a-n to inform the one or more invitees of the date and/or time change. A new notification can automatically be scheduled to be sent to the user device 102 at the new date and/or time for the call.

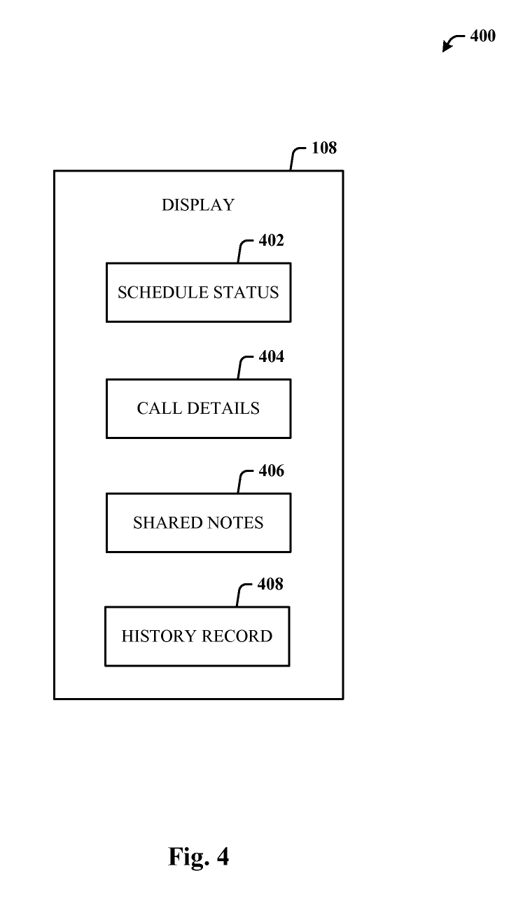

The application 108 shown in FIG. 3 (and in FIG. 4) can comprise a user interface (UI) (e.g., a display) that can provide one or more graphical user interfaces (GUIs). The GUIs can include, but is not limited to, a message interface, a mobile application interface, a command line interface, a notification interface, a start call interface, interactive buttons, user interface control, etc. For example, a GUI (e.g., touch screen GUI) can be rendered to provide a user with a region or means to load, import, read, etc., data, and can include a region to present the results of such. The region can also be used to initiate an action (e.g., start a call, reject a call, postpone a call, etc.). These regions can comprise known text and/or graphic regions comprising dialogue boxes, controls (e.g., static controls), drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed.

A user can interact with the regions to select and provide information via various devices such as a touch screen, a mouse, a roller ball, a keypad, a track pad, a keyboard, a pen and/or voice activation. In one example, a mechanism such as a push button (e.g., on the screen of the user device 102 and/or the invitee devices 106a-n) can be employed to initiate an action. In another example, a button on a keyboard can be employed to initiate an action. However, it is to be appreciated that the disclosed subject matter is not so limited. For example, merely highlighting a check box can initiate information conveyance. In another example, a command line interface can be employed. For example, a command line interface can prompt (e.g., via a text message on a display and an audio tone) the user for information via providing a text message. The user can then provide suitable information, such as alpha-numeric input corresponding to an option provided in the interface prompt or an answer to a question posed in a prompt. It is to be appreciated that a command line interface can be employed in connection with a GUI and/or an application programming interface (API). In addition, a command line interface can be employed in connection with hardware (e.g., video cards) and/or displays with graphic support.

In another aspect, the application 108 shown in FIG. 3 (and in FIG. 4) can enable a user to select buttons, controls, links, files, folders, or other items, presented by or available via the user device 102 and/or the invitee devices 106a-n. In response to selection of an item, a corresponding action can be performed, wherein, depending in part on the item selected, the action can comprise, for example, starting a call, rejecting a call, postponing a call, selecting a contact from a contact list, or entering information (e.g., information regarding a call) via the user device 102 and/or the invitee devices 106a-n.

Turning now to FIG. 4, a block diagram illustrating an example, non-limiting embodiment of a system 400 for displaying information regarding a call scheduling system is shown. The application 108 can display a schedule status 402, call details 404, shared notes 406, and/or a history record 408 on the user device 102 and/or the invitee devices 106a-n. In one example, the schedule status 402 can include information regarding the number of participants who accepted an invitation for a call. In another example, the schedule status 402 can include information regarding the participants currently involved in the call (e.g., the number of participants, the names of the participants, etc.). The call details 404 can contain information about a call after a call has ended. The call details 404 can include information including, but not limited to, a date and/or a time of the call, duration of the call, or the participants of the call. The shared notes 406 can be notes shared with participants of the call before, during, and/or after a call has taken place. In one example, the shared notes 406 can be public notes. Therefore, the shared notes 406 can be shared with all participants of the call. In another example, the shared notes 406 can be private notes. Therefore, the shared notes 406 can be shared with a select number of participants of the call. The history record 408 can include information regarding past calls of a participant. For example, the history record 408 can include, but is not limited to, a data and/or time for a past call, duration of a past call, or participants of a past call.

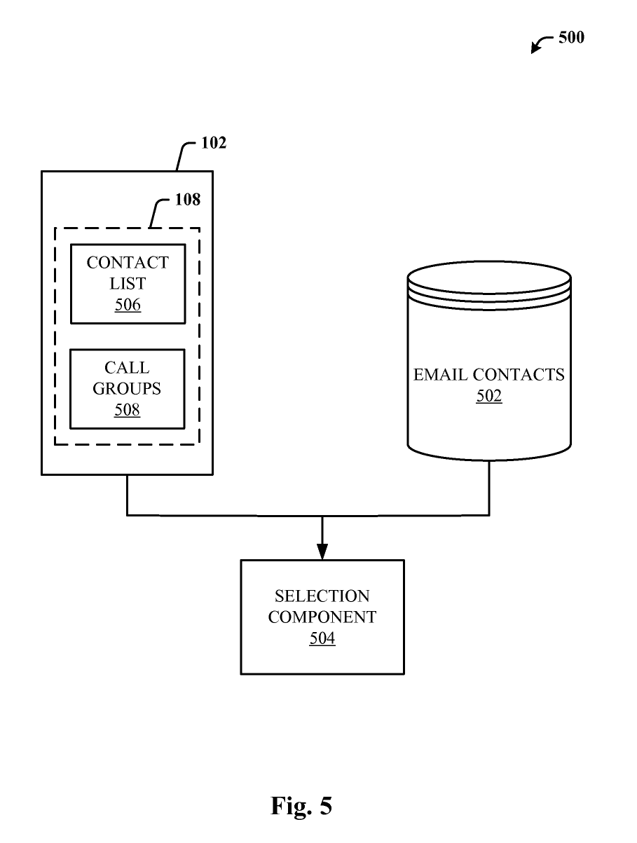

Turning to FIG. 5, a block diagram illustrating an example, non-limiting embodiment of a system 500 for selecting participants for a call schedule system is shown. The system 500 can include the user device 102, email contacts 502, and a selection component 504. The email contacts 502 can be stored in an address book on a local computer, or can be stored online, in a web based email server. The selection component 504 can assist selection of call participants based on past calls. For example, the selection component 504 can comprise lists of past participants for a particular past call. Therefore, all participants from a past call can be invited to join a new call. The user device 102 can include a contact list 506 and call groups 508. Therefore, participants for a call can be added from the contact list 506 and/or the call groups 508. The contact list 506 stored the user device 102 can be accessed by the application 108 installed the user device 102. In another example, the contact list 506 is stored on the application 108, separate from the user device 102. In one example, the contact list 506 is an address book stored on the user device 102. In another example, the contact list 506 contains web-based call service identifications (e.g., screen names). The call groups 508 can be groups of mobile phone numbers, landline phone numbers, and/or web based call service identifications. For example, the call groups 508 can be a group of numbers associated with friends, family, coworkers, or another group of individuals. The call groups 508 can be accessed by the application 108. In another example, the call groups 508 can be saved on the application 108.

The selection component 504 can assist selection of the invitees from a list of email contacts, mobile phone contacts (e.g., the contact list 506 and/or the call groups 508) stored on the user device 102, or an address book. The email contacts 502 can be stored in an address book on a local computer, or can be stored online, in a web based email server. The contact list stored on the user device 102 can be accessed by a client application installed on the user device 102. The email contacts 502, the contact list 506, and/or the call groups 508 can present a contact list of persons or entities who can be selected by a user, for example, to make a phone call, send a message, schedule a call, etc. A user can utilize the selector component 504 to select a desired call participant from the email contacts 502, the contact list 506, and/or the call groups 508. The application 108 can be used to facilitate modifying the contact to add, remove, or change information (e.g., name, phone number, geographical address, email address, etc.) relating to a person or entity.

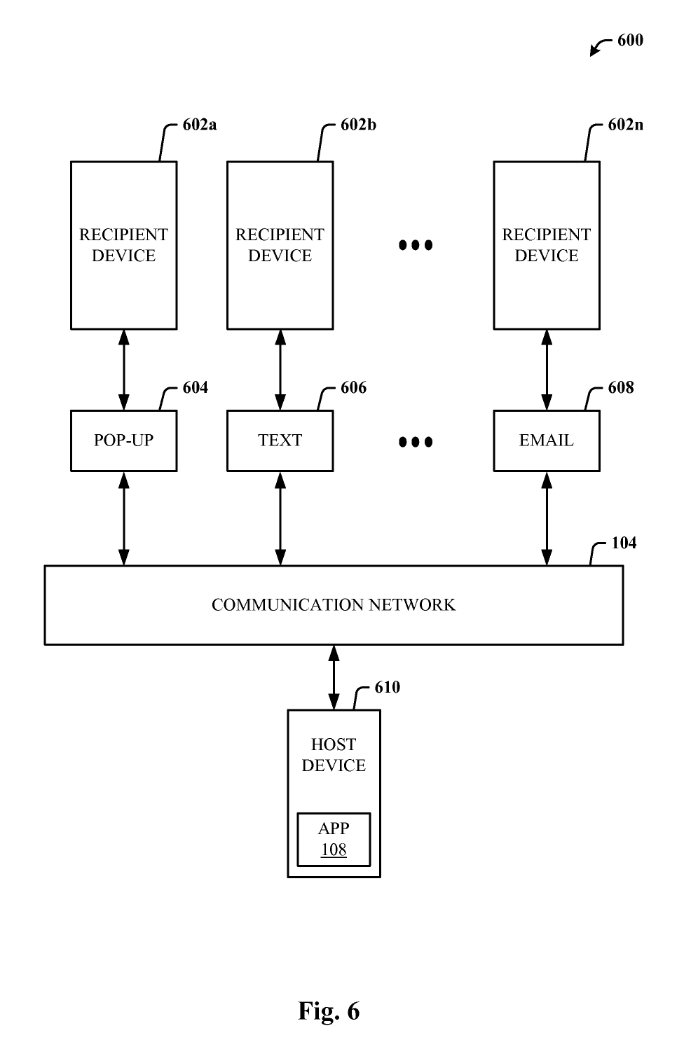

Turning to FIG. 6, a block diagram illustrating an example, non-limiting embodiment of a system 600 for sending one or more messages regarding an invitation to join a call in a call scheduling system is shown. The one or more messages can be sent via a number of different communication methods. The one or more messages can include, for example, a pop-up message 604, a text message 606, or an email 608 from the host device 610. However, it is to be appreciated that a different type of message can be used. In one example, the one or more messages comprise the same type of message (e.g., a text message). In another example, the one or more messages comprise different types of messages (e.g., a combination of pop-up messages, text messages, and/or email messages). In one example, the user can set up a date and/or time for a call using a host device 610. The call schedule application 108 can send the one or more messages (e.g., the invitation) to the one or more recipient devices 602a-n. For example, the recipient 602a can receive the invitation via the pop-up message 604, the recipient 602b can receive the invitation via the text message 606, and the recipient 602n can receive the invitation via the email 608. In one example, the pop-up message 604 is a pop-up message generated by the application 108. The application 108 can send the one or more messages based on a preference or a previous method of communication of one of the recipient devices 602a-n. Therefore, the one or more messages do not need to be sent to a device comprising the application 108. For example, a message can be sent to an email account not affiliated with the application 108. In one example, the recipient devices 602a-n are devices different than the invitee devices 106a-n. In another example, the recipient devices 602a-n are the invitee devices 106a-n.

Once the message is received by one of the one or more recipient devices 602a-n, the message can be forwarded to other recipient devices. For example, a message regarding an invitation to join the call can be forwarded to another recipient not invited by the host device 610. Therefore, the call participants are not limited to recipients invited by the host device 610. The messages forwarded to other recipient devices can be sent, for example, via the pop-up message 604, the text message 606, and/or the email 608. For example, the recipient device 602b can forward the text message 606 to a new recipient device not included in the recipient devices 602a-n in order to invite the new recipient to the call. In one example, the forwarded message can be sent to a device with access to the application 108 (e.g., the application 108 is installed on the device). In another example, the forwarded message can be sent to a device without the application 108 (e.g., the forwarded message is sent to an email account not affiliated with the application 108). A link to download the application 108 can be provided if the other recipient device does not comprise the application 108.

The recipient devices 602a-n can also send suggestions and/or comments regarding the call after receiving the invitation for the call. For example, the recipient devices 602a-n can send a comment regarding the call using the application 108. The application 108 can link all of the call participants together (e.g., link the recipient devices 602a-n that accepted the invitation and the host device 610 together). Therefore, the recipient devices 602a-n can send comments to other call participants without knowing all of the other call participants by using the application 108.

The communication network 104 can include any suitable entity enabling electronic communication between the host device 610 and the recipient devices 602a-n (e.g., the invitee devices 106a-n). The host device 610 and the recipient devices 602a-n (e.g., the invitee devices 106a-n) can each have access to the application 108 (e.g., the application 108 can be installed on the host device 610 and the invitee devices 106a-n). The communication network 104 can include a public circuit-switched telephone network, the Internet and world-wide-web, a private intranet, as well as other mobile networks (e.g., code division multiple access (CDMA) networks, global system for mobile communication (GSM) networks, universal mobile telecommunication system (UMTS) networks, high speed packet access (HSPA) networks, third generation partnership project long term evolution (3GPP LTE) networks, worldwide interoperability for microwave access (WiMAX) networks, WiFi networks, and so on), or the like, or suitable combinations thereof.

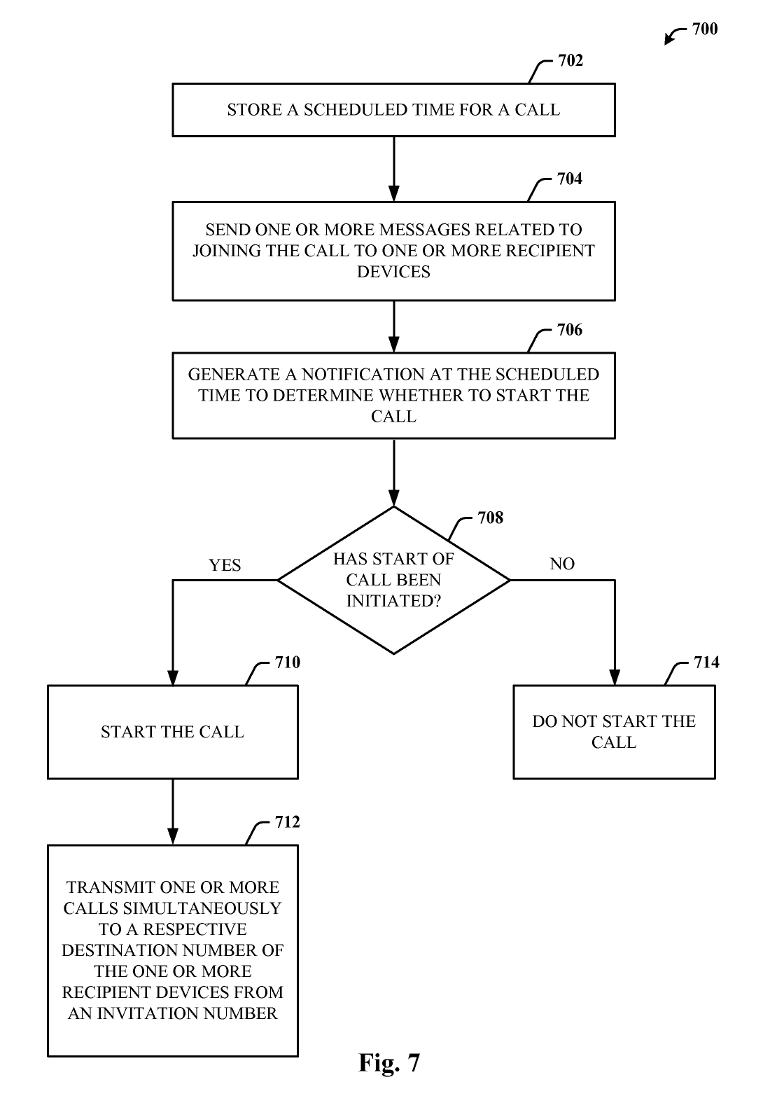

In view of the example systems described supra, methods that may be implemented in accordance with the disclosed subject matter may be better appreciated with reference to the flow charts of FIGS. 7-12. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, illustrated is an example methodology 700 for implementing a call scheduling system in accordance with aspects described herein. Methodology 700 can begin at block 702, wherein a scheduled time for a call is stored. For example, a user can set a time and date for a conference call using an application on the user device 102. The time and date for the conference call can then be stored in a storage device (e.g., the storage component 208). At 704, one or more messages related to joining the call is sent to one or more recipient devices. For example, a number of contacts stored in an address book on the user device 102 can be invited to join the conference call at the scheduled time. Therefore, one or more messages (e.g., a text message, an email message, a pop-up message, etc.) inviting the contacts to join the call at the scheduled time can be sent to one or more recipient devices (e.g., the invitee devices 106a-n). At 706, a notification at the scheduled time is generated to determine whether to start the call. For example, the user device 102 can receive a notification at the scheduled time on the user device 102. The notification can provide a number of options, such as start the call, reject the call, or postpone the call. At 708, it is determined if the start of the call has been initiated. For example, it can be determined if a button (e.g., a start control, a user interface control) has been pressed on the user device 102 to start the conference call. If yes, 710 starts the call. Then at 712, one or more calls are simultaneously transmitted to a respective destination number (e.g., a phone number) of the one or more recipient devices from an invitation number (e.g., phone number). The invitation number can be a phone number associated with the user device 102. The one or more calls can be automatically transmitted in response to an action to initiate the call. For example, the invitee devices 106a-n can be simultaneously called (e.g., the invitee devices 106a-n can simultaneously ring) in response to a call from the user device 102 initiated by pressing a button on the user device 102. If no, 714 does not start the call. For example, the conference call can be cancelled or rescheduled for a later time and/or date.

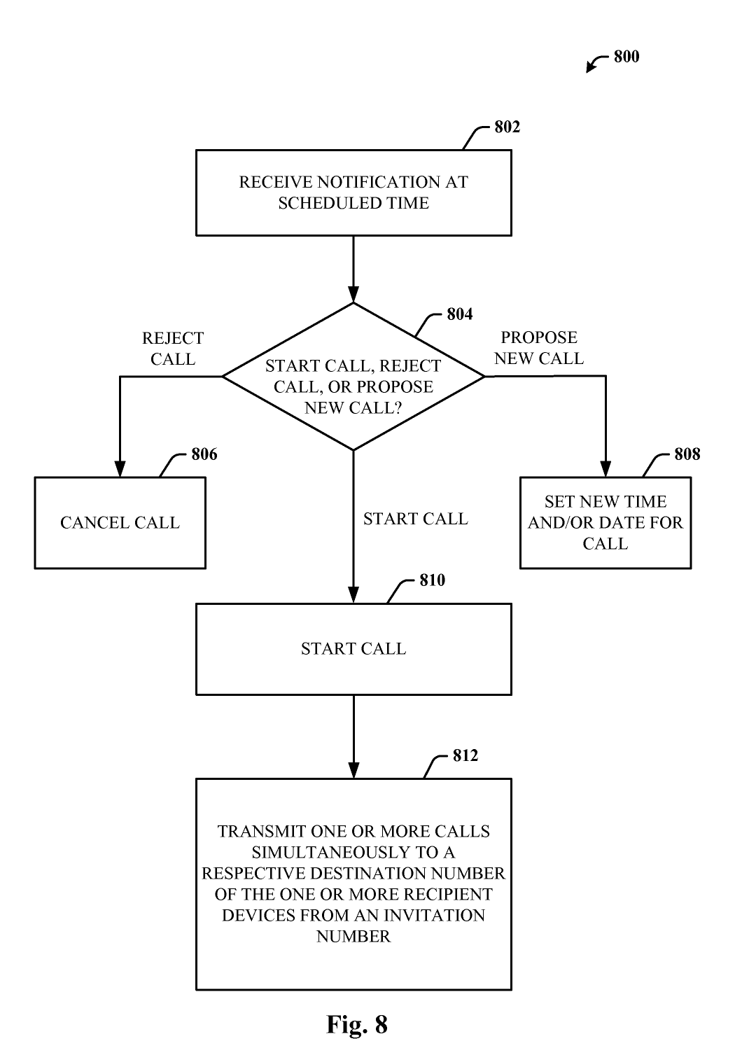

Referring to FIG. 8, illustrated is an example methodology 800 for managing a call schedule system in accordance with aspects described herein. Methodology 800 can begin at block 802, wherein a notification at a scheduled time is received. For example, a user can receive a notification on the user device 102 at a previously scheduled date and time for a call. At 804, it is determined whether to start the call, reject the call, or propose a new call. If it is decided to reject the call, 806 cancels the call. If it is decided to propose a new call, 808 sets a new time and/or date for the call. Therefore, the call can be postponed until a later date and/or time. If it is decided to start the call, 810 starts the call. Then at 812, one or more calls are simultaneously transmitted to a respective destination number (e.g., a phone number) of one or more recipient devices from an invitation number (e.g., phone number). The one or more calls can be automatically sent to the one or more recipient devices (e.g., the invitee devices 106a-n) in response to a signal initiating the start of the call. For example, a button on the user device 102 can be pushed to start the call.

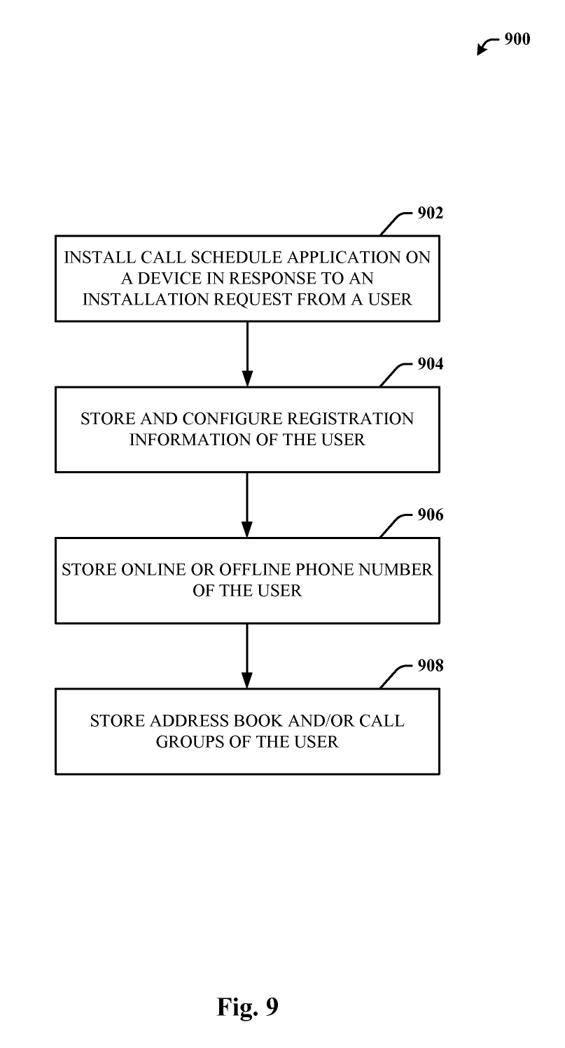

Referring to FIG. 9, illustrated is an example methodology 900 for initializing a call scheduling system in accordance with aspects described herein. Methodology 900 can begin at block 902, wherein a call schedule application is installed on a device in response to an installation request of a user. For example, an application can be installed on the user device 102 and/or the invitee devices 106a-n (e.g., a mobile phone, a desktop, a laptop, a tablet, etc.). In one example, a user can download the application from a web-based server. Additionally or alternatively, the application can be a web-based application accessible through a web browser on the user device 102, the invitee devices 106a-n, or another device with access to the internet. At 904, registration information of the user can be stored and configured. For example, information about the user (e.g., name of the user, address of the user, preferences of the user, type of device implementing the call schedule application, etc.) can be stored on a web-based server. The user can create a user profile (e.g., register) for the call schedule application 108 by registering on an online website. At 906, an online or offline phone number of the user is stored. For example, the user can add a mobile phone number, a landline phone number, or a phone number associated with an online call service to be stored on a web-based server. Therefore, a call at the scheduled time can be sent from the provided user phone number (e.g., an invitation number) to the call invitees. Additionally, call participants can be connected to the provided user phone number at the scheduled time for a call. At 908, an address book and/or a call group of the user can be stored. For example, the user can add phone numbers of potential call participants (e.g., contacts). Additionally or alternatively, the user can add web-based call service identifications (e.g., screen names) of contacts associated with a web or traditional phone number. The address book and/or the call group can be stored on a device (e.g., the user device 102) and/or a web-based server. Therefore, the user can use the address book and/or the call groups to invite one or more contacts to join a call.

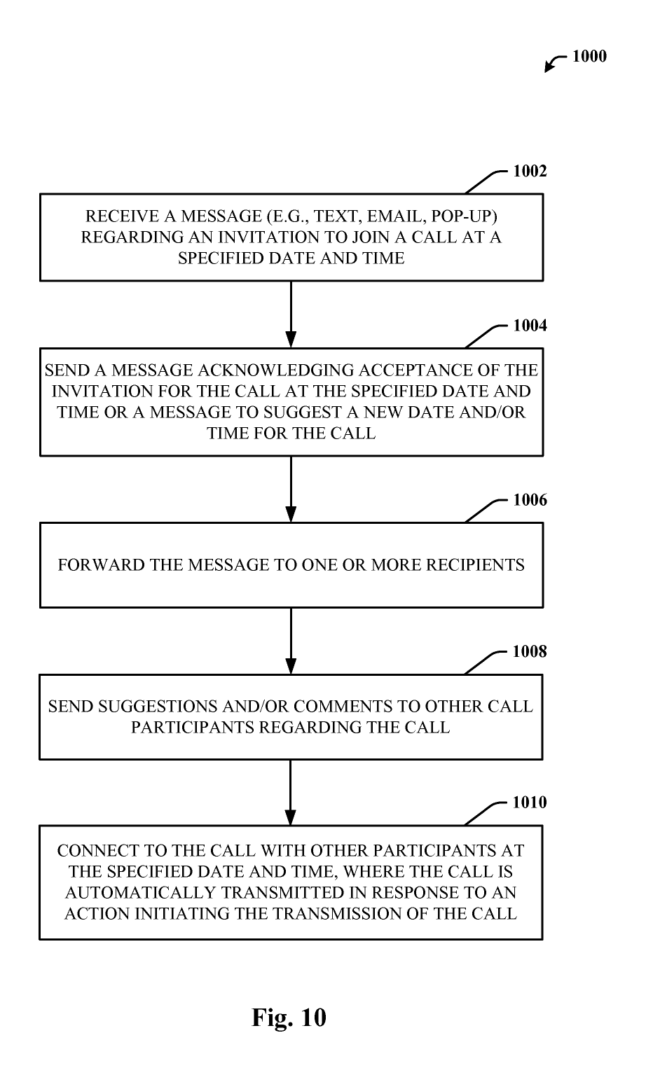

Referring to FIG. 10, illustrated is an example methodology 1000 for participating in a call scheduling system in accordance with aspects described herein. Methodology 1000 can begin at block 1002, wherein a message (e.g., a text message, an email message, a pop-up message, etc.) regarding an invitation to join a call at a specified date and time is received. For example, one or more of the invitee devices 106a-n can receive a message sent from the user device 102 for a call at a scheduled date and time. At 1004, a message acknowledging acceptance of the invitation for the call at the specified date and time or a message to suggest a new date and/or time for the call can be sent. For example, a button can be pushed on one or more of the invitee devices 106a-n to accept the invitation for the call. As a result, the user device and the other invitee devices 106a-n can be notified of the acceptance. In another example, a new date and/or time for the call can be sent from one of the invitee devices 106a-n to the user device 102. The call can be automatically scheduled for the new date and/or time if the new date and/or time is accepted by a call host (e.g., the user device 102). At 1006, the invitation for the call is forwarded to one or more recipients. For example, one of the invitees can forward the invitation for the call to a device not included in the invitee devices 106a-n. Therefore, other users not originally invited by the user device 102 can be included in the scheduled call. At 1008, suggestion and/or comments are sent to other call participants regarding the call. For example, one of the invitee devices 106a-n can send a comment regarding the scheduled call to the other call participants. At 1010, a connection is established with other call participants at the specified date and time. For example, one of the invitee device 106a-n can answer a call from the user device 102 to establish a connection (e.g. a call) with the user device 102 and the other invitee devices 106a-n. The call is automatically transmitted in response to an action initiating the transmission of the call. For example, the invitee devices 106a-n are not required to call the user device 102 to join the call. Instead, the user device 102 can simultaneously call the invitee devices 106a-n.

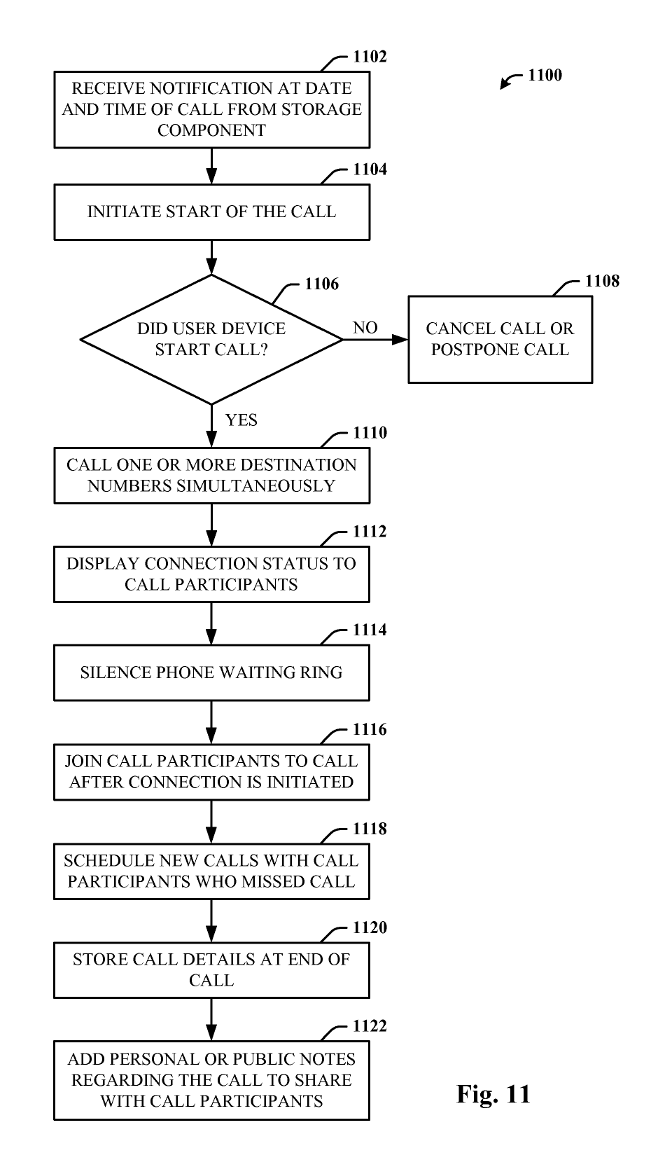

Referring to FIG. 11, illustrated is an example methodology 1100 for facilitating a call scheduling system in accordance with aspects described herein. Methodology 1100 can begin at block 1102, wherein a notification at a date and time for a call is received from a storage component. For example, a signal can be received by the management component 204 and/or the initiation component 206 from the storage component 208 at a scheduled time. At 1104, the start of the call is initiated. For example, the initiation component 206 can send a notification to the user device 102 at the scheduled time for a call to initiate starting the call. At 1106, it is determined whether a user device started the call. For example, it can be determined whether an action to initiate the start of the call (e.g., pushing a start button on the user device 102) has occurred. If no, 1108 cancels the call or postpones the call. For example, the call can be postponed by scheduling a new call at a later date and/or time. If yes, 1110 calls one or more destination numbers simultaneously. For example, one or more destination numbers (e.g., phone numbers of the invitee devices 106a-n) can be called (e.g., can ring) simultaneously. At 1112, a connection status is displayed to call participants. For example, information regarding the number of call participants currently connected to the call can be displayed on the user device 102 and/or the invitee devices 106a-n. At 1114, a waiting ring on a phone is silenced. For example, the user device 102 can call the invitee devices 106a-n without hearing a ringing sound. Therefore, the call can start between the user device 102 and a select number of the invitee devices 106a-n that have answered the call while waiting for the other invitee devices 106a-n to answer the call. At 1116, call recipients are joined to the call after a connection is initiated. For example, one or more of the invitee devices 106a-n can join the call with the user device 102 (e.g., a connection is established between one or more of the invitee devices 106a-n and the user device 102). At 1118, new calls with call participants who missed the call are scheduled. For example, if one of the invitees missed the call, a new call at a later date and/or time can be scheduled. In one example, one of the invitee devices 106a-n can generate a message (e.g., a text message, an email message, a pop-up message, etc.) with a proposed time and/or date for a new call. The user device 102 can receive the message with the proposed time and/or date for the new call. As a result, the proposed time and/or date for the new call can be accepted, and automatically scheduled, or rejected using the user device 102. At 1120, call details are stored at the end of the call. For example, details including duration of the call, call participants, a date and a time of the call, etc. can be stored and shared with the user device 102 and/or the invitee devices 106a-n. At 1122, personal or public notes regarding the call are sent the call participants. For example, a note (e.g., a comment, a remark, etc.) regarding the call from one of the invitee devices 106a-n can be shared with the user device 102. In another example, a note (e.g., comment, remark, etc.) from one of the invitee devices 106a-n can be shared with the user device 102 and the other invitee devices 106a-n.

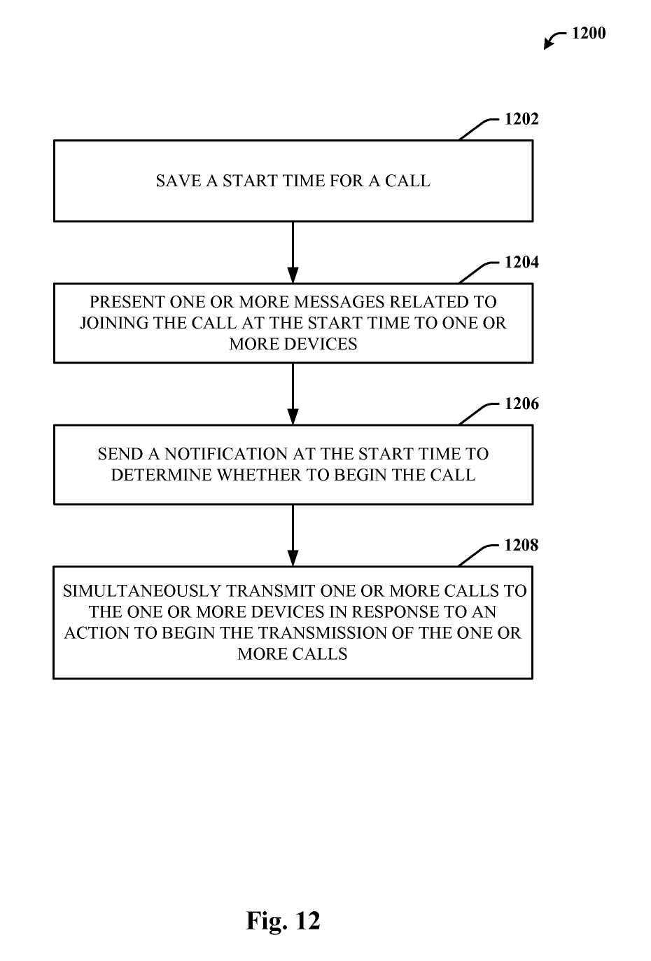

Referring to FIG. 12, illustrated is an example methodology 1200 for a call scheduling system in accordance with aspects described herein. Methodology 1200 can begin at block 1202, wherein a start time for a call is saved. For example, a call host can establish a start time for a call by using the user device 102. The start time can then be saved on a storage device. At 1204, one or more messages related to joining the call at the start time can be presented to one or more devices. For example, the user device 102 can send a message (e.g., a text message, a pop-up message, an email message) to one or more invitee devices 106a-n to requesting one or more invitees to join a call at the start time. At 1206, a notification at the start time is sent to determine whether to begin the call. For example, the call host can receive a notification on the user device 102 at the start time for the call. The notification can present a number of options for the call host to choose, such as start the call, cancel the call, or postpone the call. At 1208, the one or more calls are simultaneously transmitted to the one or more devices in response to an action to begin the transmission of the one or more calls. For example, the call host can push a button on the user device 102. In response to pushing the button on the user device 102, one or more calls can be simultaneously transmitted to the invitee devices 106a-n.

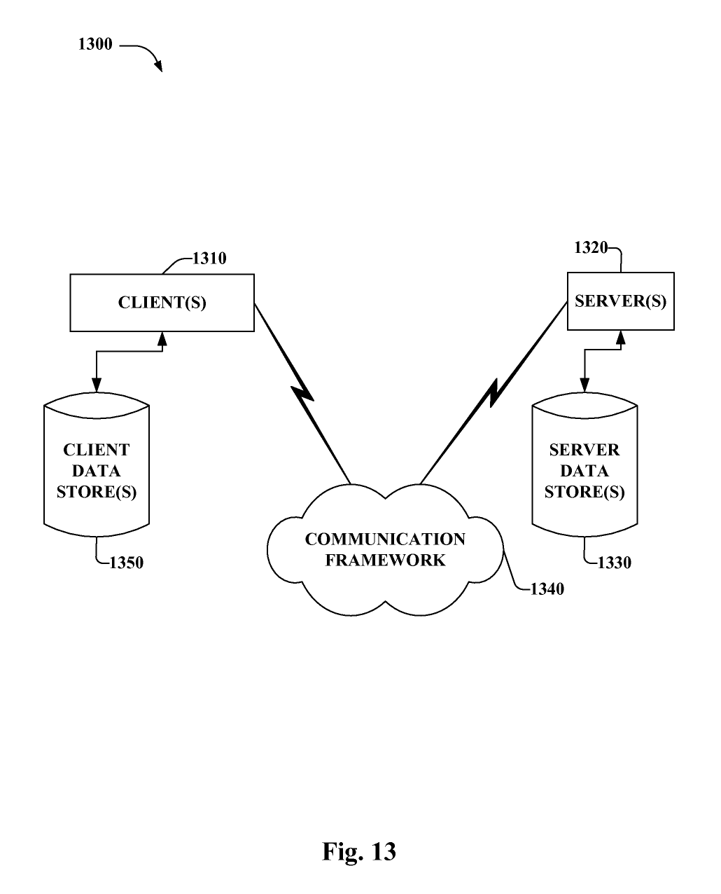

Turning now to FIG. 13 block diagram illustrating an example networking environment that can be employed in accordance with the claimed subject matter is shown. The system 1300 includes one or more client(s) 1310. The client(s) 1310 can be hardware and/or software (e.g., threads, processes, computing devices). The system 1300 also includes one or more server(s) 1320. The server(s) 1320 can be hardware and/or software (e.g., threads, processes, computing devices). The servers 1320 can house threads to perform transformations by employing the subject innovation, for example.

One possible communication between a client 1310 and a server 1320 can be in the form of a data packet adapted to be transmitted between two or more computer processes. The system 1300 includes a communication framework 1340 that can be employed to facilitate communications between the client(s) 1310 and the server(s) 1320. The client(s) 1310 are operably connected to one or more client data store(s) 1350 that can be employed to store information local to the client(s) 1310. Similarly, the server(s) 1320 are operably connected to one or more server data store(s) 1330 that can be employed to store information local to the servers 1320.

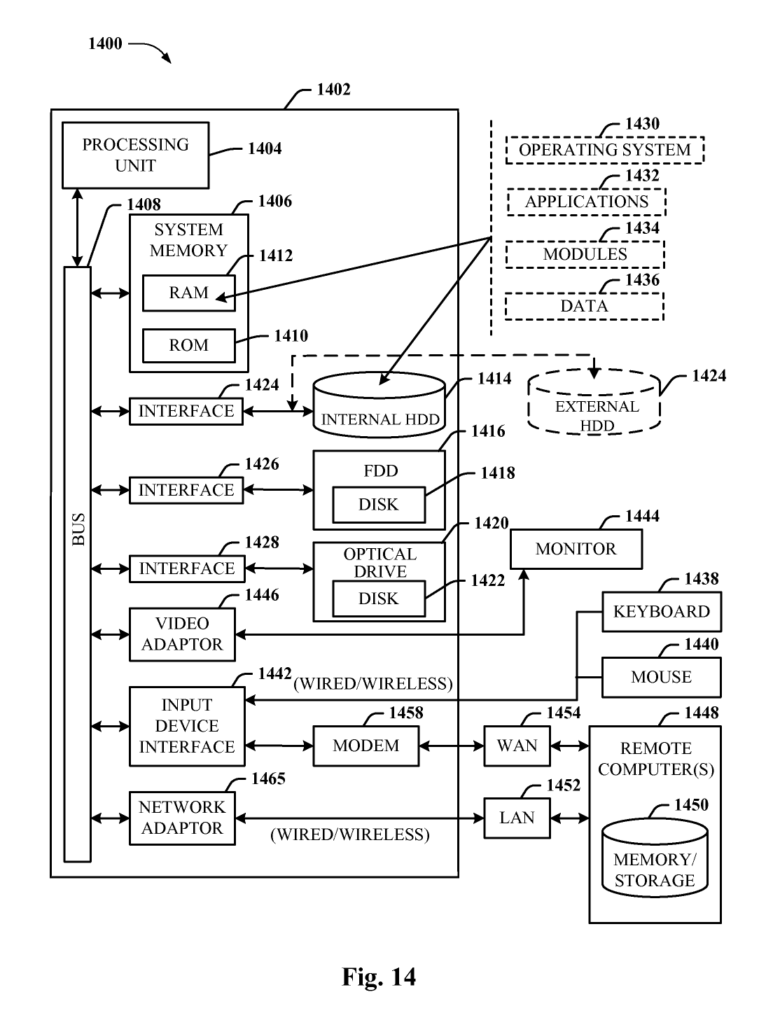

Referring now to FIG. 14, there is illustrated a block diagram of a computer operable to provide networking and communication capabilities between a wired or wireless communication network and a server and/or communication device. In order to provide additional context for various aspects thereof, FIG. 14 and the following discussion are intended to provide a brief, general description of a suitable computing environment 1400 in which the various aspects of the innovation can be implemented. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the exemplary environment 1400 for implementing various aspects includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 can also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1411 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is to be appreciated that the innovation can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 2394 serial port, a game port, a USB port, an IR interface, etc.

A monitor 1444 or other type of display device is also connected to the system bus 1408 through an interface, such as a video adapter 1446. In addition to the monitor 1444, a computer typically includes other peripheral output devices (not shown), such as speakers, printers, etc.

The computer 1402 can operate in a networked environment using logical connections by wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adaptor 1456 may facilitate wired or wireless communication to the LAN 1452, which may also include a wireless access point disposed thereon for communicating with the wireless adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 through the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least wireless fidelity (WiFi) and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11(a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

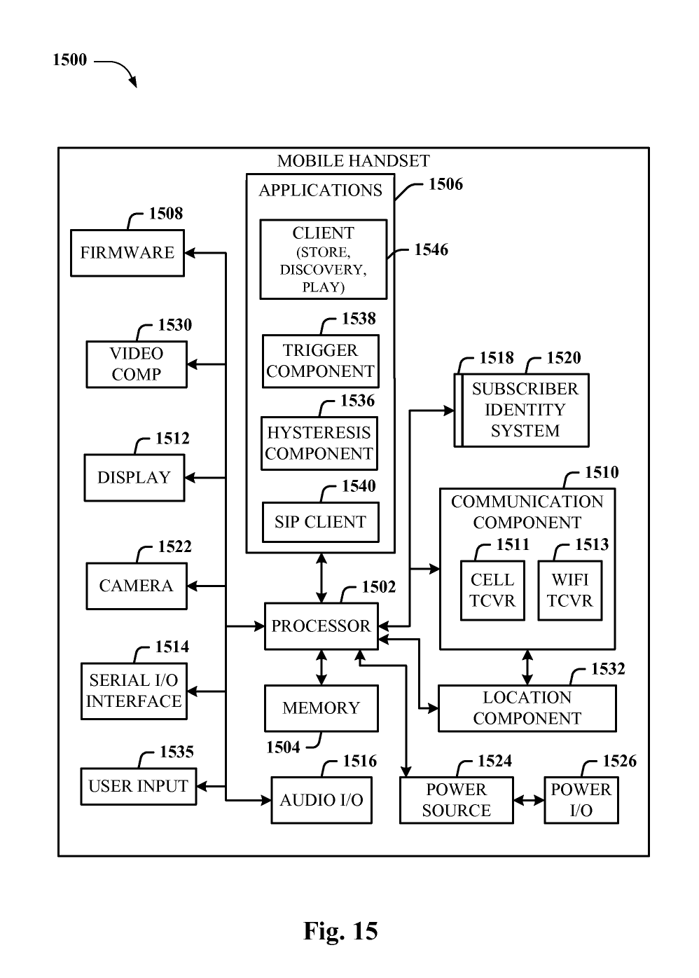

FIG. 15 illustrates a schematic block diagram of an exemplary device 1500 capable of employing the subject system in accordance with some embodiments of the invention. The device is a mobile handset 1500 In order to provide additional context for various aspects thereof, FIG. 15 and the following discussion are intended to provide a brief, general description of a suitable environment 1500 in which the various aspects can be implemented. While the description includes a general context of computer-executable instructions, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the inventive methods can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer-readable media. Computer readable media can be any available media that can be accessed by the computer and includes both volatile and non-volatile media, removable and non-removable media. By way of example and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1500 includes a processor 1502 for controlling and processing all onboard operations and functions. A memory 1504 interfaces to the processor 1502 for storage of data and one or more applications 1506 (e.g., a video player software, user feedback component software, . . . ). Other applications can include voice recognition of predetermined voice commands that facilitate initiation of the user feedback signals. The applications 1506 can be stored in the memory 1504 and/or in a firmware 1508, and executed by the processor 1502 from either or both the memory 1504 or/and the firmware 1508. The firmware 1508 can also store startup code for execution in initializing the handset 1500. A communications component 1510 interfaces to the processor 1502 to facilitate wired/wireless communication with external systems, e.g., cellular networks, VoIP networks, and so on. Here, the communications component 1510 can also include a suitable cellular transceiver 1511 (e.g., a GSM transceiver) and an unlicensed transceiver 1513 (e.g., WiFi, WiMax) for corresponding signal communications. The handset 1500 can be a device such as a cellular telephone, a PDA with mobile communications capabilities, and messaging-centric devices. The communications component 1510 also facilitates communications reception from terrestrial radio networks (e.g., broadcast), digital satellite radio networks, and Internet-based radio services networks.

The handset 1500 includes a display 1512 for displaying text, images, video, telephony functions (e.g., a Caller ID function), setup functions, and for user input. The display 1512 can also accommodate the presentation of multimedia content (e.g., music metadata, messages, wallpaper, graphics, . . . ). A serial I/O interface 1514 is provided in communication with the processor 1502 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1500, for example. Audio capabilities are provided with an audio I/O component 1516, which can include a speaker for the output of audio signals related to, for example, indication that the user pressed the proper key or key combination to initiate the user feedback signal. The audio I/O component 1516 also facilitates the input of audio signals through a microphone to record data and/or telephony voice data, and for inputting voice signals for telephone conversations.

The handset 1500 can include a slot interface 1518 for accommodating a SIC (Subscriber Identity Component) in the form factor of a card Subscriber Identity Module (SIM) or universal SIM 1520, and interfacing the SIM card 1520 with the processor 1502. However, it is to be appreciated that the SIM card 1520 can be manufactured into the handset 1500, and updated by downloading data and software thereto.

The handset 1500 can process IP data traffic through the communication component 1510 to accommodate IP traffic from an IP network such as, for example, the Internet, a corporate intranet, a home network, a person area network, etc., through an ISP or broadband cable provider. Thus, VoIP traffic can be utilized by the handset 1500 and IP-based multimedia content can be received in either an encoded or decoded format.

A video processing component 1522 (e.g., a camera) can be provided for decoding encoded multimedia content. The handset 1500 also includes a power source 1524 in the form of batteries and/or an AC power subsystem, which power source 1524 can interface to an external power system or charging equipment (not shown) by a power I/O component 1526.

The handset 1500 can also include a video component 1530 for processing video content received and, for recording and transmitting video content. A location tracking component 1532 facilitates geographically locating the handset 1500. As described hereinabove, this can occur when the user initiates the feedback signal automatically or manually. A user input component 1534 facilitates the user initiating the quality feedback signal. The input component can include such conventional input device technologies such as a keypad, keyboard, mouse, stylus pen, and touch screen, for example.

Referring again to the applications 1506, a hysteresis component 1536 facilitates the analysis and processing of hysteresis data, which is utilized to determine when to associate with the access point. A software trigger component 1538 can be provided that facilitates triggering of the hysteresis component 1538 when the WiFi transceiver 1513 detects the beacon of the access point. A SIP client 1540 enables the handset 1500 to support SIP protocols and register the subscriber with the SIP registrar server. The applications 1506 can also include a client 1542 that provides at least the capability of discovery, play and store of multimedia content, for example, music.

The handset 1500, as indicated above related to the communications component 1510, includes an indoor network radio transceiver 1513 (e.g., WiFi transceiver). This function supports the indoor radio link, such as IEEE 802.11, for the dual-mode GSM handset 1500. The handset 1500 can accommodate at least satellite radio services through a handset that can combine wireless voice and digital radio chipsets into a single handheld device.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A method, comprising:
storing a scheduled time for a call;
sending one or more messages related to joining the call at the scheduled time to one or more recipient devices;
generating a notification at the scheduled time to determine whether to start the call; and
transmitting one or more calls simultaneously to a respective destination number of the one or more recipient devices from an invitation number in response to an action initiating the start of the call.

2. The method of claim 1, wherein the initiating the start of the call includes pushing a user interface control on a host device associated with the invitation number.

3. The method of claim 1, further comprising storing a new scheduled time for the call in response to the notification.

4. The method of claim 1, further comprising connecting the respective destination number of the one or recipient devices to the call with the invitation number.

5. The method of claim 4, further comprising displaying a connection status of the one or more recipient devices.

6. The method of claim 1, further comprising allowing the one or more recipient devices to join the call after the scheduled time for the call in response to a determination that the call has not ended.

7. The method of claim 1, further comprising presenting an option to establish a future call after the call has ended in response to a determination that a particular one of the one or more recipient devices did not participate in the call.

8. The method of claim 1, further comprising automatically scheduling a new call with the one more recipient devices that missed the call.

9. The method of claim 1, further comprising storing details of the call, including one or more of a history record, the time of the call, the date of the call, a duration of the call or participants of the call.

10. The method of claim 1, further comprising sending comments regarding the call to the one or more recipient devices.

11. The method of claim 1, wherein the storing the scheduled time for the call includes determining the scheduled time based on a calendar associated with the one or more recipient devices.

12. The method of claim 11, wherein the generating the notification includes displaying the notification on a mobile phone.

13. The method of claim 1, wherein the sending the one or more messages includes sending one or more of an email, a text message or a message generated by an application installed on the one or more recipient devices.

14. The method of claim 1, wherein the transmitting the one or more calls includes transmitting one or more mobile phone numbers, one or more landline phone numbers, or one or more web-based phone numbers.

15. A call schedule system, comprising:
a schedule component configured to set a scheduled time for a call;
a management component configured to send one or more messages related to an invitation to join the call at the scheduled time to one or more recipient devices; and
an initiation component configured to generate a notification at the scheduled time to determine whether to start the call and automatically transmit one or more calls simultaneously to a respective destination number of the one or more recipient devices from an invitation number in response to an action to initiate the start of the call.

16. The call schedule system of claim 15, wherein the call is initiated by pushing a start control on a host device associated with the invitation number.

17. The call schedule system of claim 15, wherein the management component is further configured to generate a connection status of the one or more recipient devices.

18. The call schedule system of claim 15, wherein the schedule component is further configured to connect the one or more recipient devices to the call after the scheduled time for the call in response to a determination that the call has not ended.

19. The call schedule system of claim 15, wherein the schedule component is further configured to establish a future call after the call has ended in response to a determination that a particular one of the one or more recipient devices did not participate in the call.

20. The call schedule system of claim 15, wherein the schedule component is further configured to automatically schedule a new call with the one more recipient devices that missed the call.

21. The call schedule system of claim 15, further comprising a storage component configured to store details of the call including one or more of a history record, the time of the call, the date of the call, a duration of the call or participants of the call.

22. A computer readable storage medium comprising computer executable instructions that, in response to execution by a computing system, cause the computing system to perform operations, comprising:
storing a scheduled time for a call;
sending one or more messages related to joining the call at the scheduled time to one or more recipient devices;
generating a notification at the scheduled time to determine whether to start the call; and
transmitting one or more calls simultaneously to a respective destination number of the one or more recipient devices from an invitation number in response to an action initiating the start of the call.

23. The computer readable storage medium of claim 22, wherein the initiating the start of the call includes pushing a button on a host device associated with the invitation number.

24. The computer readable storage medium of claim 22, further comprising storing a new scheduled time for the call in response to the notification.

25. The computer readable storage medium of claim 22, further comprising allowing the one or more recipient devices to join the call after the scheduled time for the call in response to a determination that the call has not ended.

26. The computer readable storage medium of claim 22, further comprising presenting an option to establish a future call after the call has ended in response to a determination that a particular one of the one or more recipient devices did not participate in the call.

27. The computer readable storage medium of claim 22, further comprising automatically scheduling a new call with the one more recipient devices that missed the call.

28. The computer readable storage medium of claim 22, further comprising storing details of the call, including one or more of a history record, the time of the call, the date of the call, a duration of the call or participants of the call.

29. A system, comprising:
means for storing a scheduled time for a call;
means for sending one or more messages related to joining the call at the scheduled time to one or more recipient devices;
means for generating a notification at the scheduled time to determine whether to start the call; and
means for transmitting one or more calls simultaneously to a respective destination number of the one or more recipient devices from an invitation number in response to an action initiating the start of the call.

30. A method, comprising:
saving a start time for a call;
presenting one or more messages related to joining the call at the start time to one or more devices;
sending a notification at the start time to determine whether to begin the call; and
transmitting one or more calls simultaneously to the one or more devices in response to an action to begin the transmitting of the one or more calls.

31. The method of claim 30, wherein the transmitting of the one or more calls is begun in response to pushing a user interface control on a user device.

32. The method of claim 30, further comprising offering an option to set up a future call after the call has ended in response to a determination that a particular one of the one or more devices did not participate in the call.

33. The method of claim 30, further comprising automatically scheduling a new call with the one more devices that missed the call.
